(19) United States
(12) Patent Application Publication
(10) Pub. No.: US 2008/0155789 A1
(43) Pub. Date: Jul. 3, 2008

(54) PINCH OFF CLAMP

(76) Inventor: James J. Patterson, Vancouver, WA (US)

Correspondence Address: PATENTTM.US, P. O. BOX 82788, PORTLAND, OR, 97282-0788, US

(21) Appl. No.: 11/616,797

(22) Filed: Dec. 27, 2006

(51) Int. Cl. F16L 33/00

(52) U.S. Cl. 24/19; 24/498

(57) ABSTRACT

A hose clamp for temporarily clamping bellows hoses or the like to stop liquid flow during repair or maintenance work include first and second jaws hingedly connected, and a locking cam for securing the jaws into a closed position or for unlocking to enable opening of the jaws for installation or release from a hose being clamped.

### BACKGROUND OF THE INVENTION

This invention relates to clamps, and more particularly to a hose clamp for temporarily pinching a hose to a closed position.

It is sometimes desirable to clamp a hose shut, such as in a repair situation, in order to prevent fluid or the like from flowing through the hose while repairs are being made on a piece of machinery.

In a particular example, in washing machine repair and maintenance, it is desirable to clamp closed a bellows configuration hose that connects the washing machine basin to the drain pump, to enable the pump to be removed for maintenance while keeping the water remaining in the hose from running out onto the floor around the washing machine.

In the past, a repair person would use a radiator hose clamp to tighten the walls of the bellows type hose. While effective, such a clamp takes a substantial amount of time to install and tighten to a sufficient extent to clamp the bellows hose shut to prevent or minimize leakage.

### SUMMARY OF THE INVENTION

In accordance with the invention, a pinch off hose clamp is provided that has a pair of hinged jaws and a quick release lock mechanism for enabling the clamp to be quickly installed and locked onto a hose for clamping the hose shut.

Accordingly, it is an object of the present invention to provide an improved clamp for hoses.

It is a further object of the present invention to provide an improved clamp adapted for use on bellows type hoses.

It is yet another object of the present invention to provide an improved clamp for hoses that is and quickly and easily installed and uninstalled.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a side view of the pinch off clamp in accordance with the invention, shown in a closed position;

FIG. 2 is an end view of the clamp of FIG. 1, looking in the direction of arrow 2 of FIG. 1;

FIG. 3 an end view of the clamp of FIG. 1, looking in the direction of arrow 3 of FIG. 1;

FIG. 4 is an opposite side view of the pinch off clamp in an open position;

FIG. 5 is a side view of a first connection member of the clamp;

FIG. 6 is a side view of a second connection member of the clamp;

FIG. 7 is a top view of the clamp as installed and clamped on a bellows style hose; and

FIG. 8 is an end view of the clamp as installed and clamped on an accordion style hose, looking in the direction of arrow 8 in FIG. 7.

### DETAILED DESCRIPTION

The system according to a preferred embodiment of the present invention comprises a clamp member that quickly fits around and clamps shut a hose.

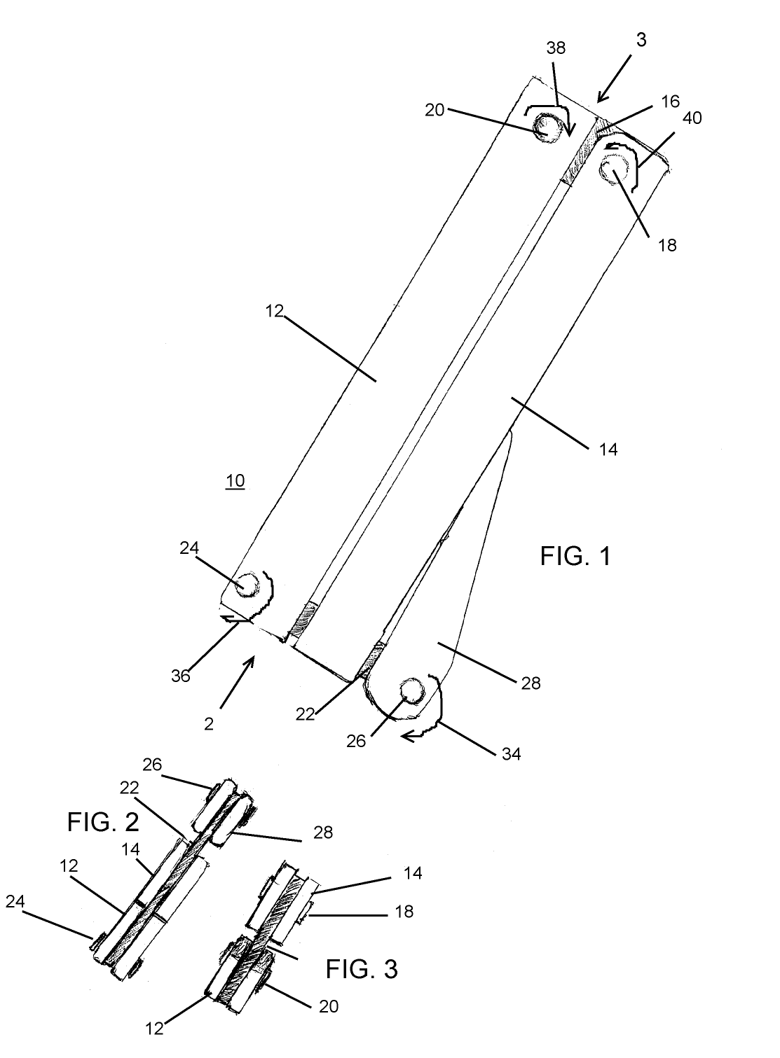

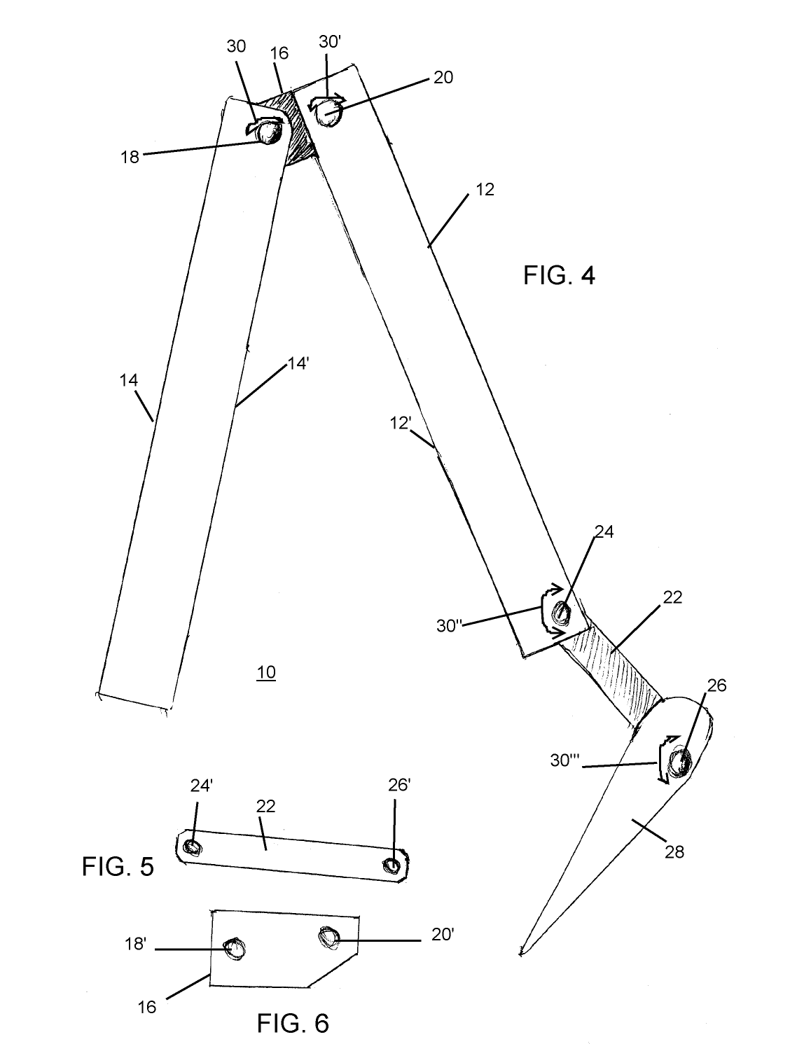

Referring to FIG. 1 and FIG. 4, opposite side views of the clamp in a closed and open position, the clamp 10 comprises first and second elongate clamp jaw arms 12, 14, which are hingedly attached at a first end by connection member 16, suitably connected to the jaw arms 12, 14 by pins 18, 20 to enable rotational movement of the jaw arms about the pins. At the end of jaw arm 12 that is distal from pin 20, a pin 24 rotationally mounts a first end of an elongate latch arm 22 to arm 12, the second end of clamp arm 22 having a latching cam 28 rotationally mounted thereto by pin 26. Arms 12, 14 have slots defined in the ends thereof to receive member 16 and latch arm 22 therein, the slots being somewhat wider than the thickness of member 16 and arm 22, to enable the rotation about the pins.

FIG. 5 and 6 illustrate exemplary shapes of connection member 16 and latch arm 22, with the respective placement of holes 18′, 20′, 24′ and 26′ for receiving the pins 18, 20, 24 and 26 therethrough.

FIGS. 2 and 3 are opposite end views of the clamp to illustrate the appearance thereof in direction of arrow 2 and 3 of FIG. 1. Note that locking cam 28 has been removed for ease of illustration in FIG. 3.

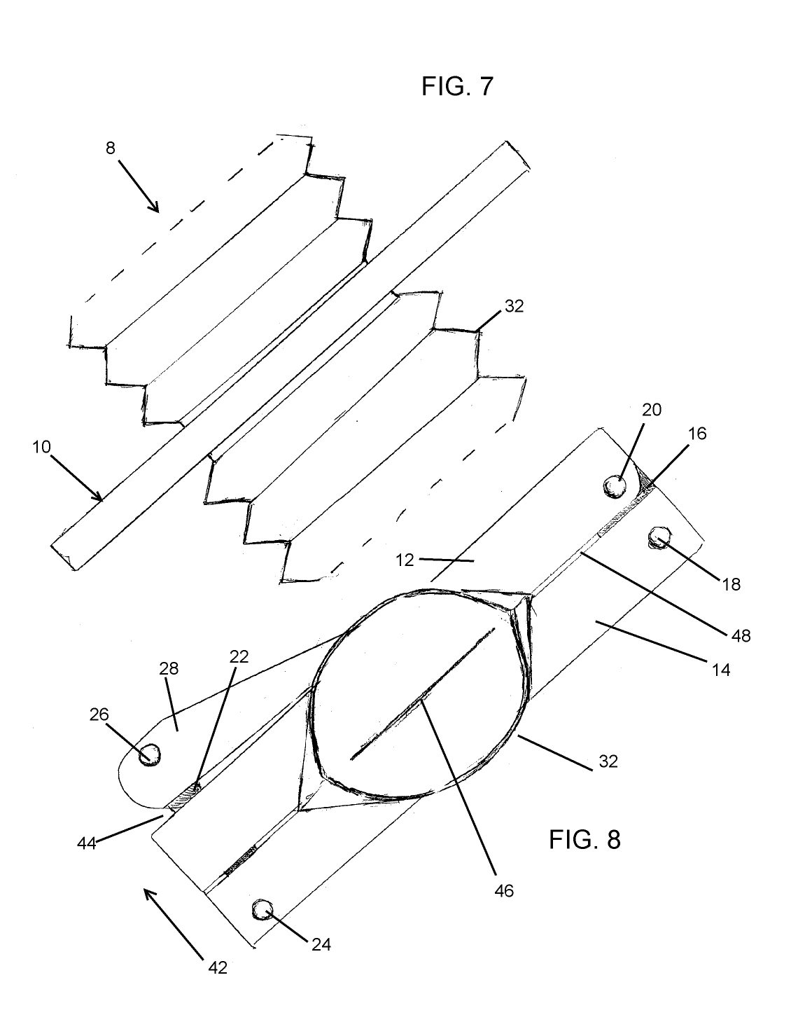

In operation, the clamp arms 12, 14, 22 and cam 28 are free to rotate about the axes defined pins 18, 20, 24 and 26 as indicated by arrows 30, 30′, 30″ and 30′″. Referring to FIGS. 1, 4, 7 and 8, to clamp closed a bellows hose 32, assuming the clamp is initially in the configuration of FIG. 1, the clamp 10 is opened to the approximate configuration of FIG. 4 (or as wide as necessary for the particular hose) by rotation of cam 28 in the direction of arrow 34 of FIG. 1, which enables arm 22 to rotate in the direction of arrow 36 about pin 24 and arms 12, 14 to rotate around pins 20 and 18 as indicated by arrows 38, 40, enabling the clamp to open to the configuration of FIG. 4, or wider as needed. Referring to FIG. 7 and 8, the clamp is positions such that bellows hose 32 is positioned between the interior surfaces 12′, 14′ of the clamp arms. The clamp arms are then rotated in the opposite directions of those of arrows 38, 40, to close the clamp around the bellows hose 32. Arm 22 is then swung around in the opposite direction of arrow 36, to bring the cam 28 up into position next to arm 14. The cam is then rotated in the opposition direction of arrow 34, resulting in the clamp being closed about the hose as shown in FIG. 8, with the hose being thereby clamped shut at central portion 46, which would otherwise form an open passage for liquid or the like to pass therethrough in absence of clamping. The hose will bias the clamp toward the direction of arrow 42, causing the gap 44 shown in FIG. 8 to be closed up so that cam 28 is flush against arm 14. (FIG. 1).

Cam portion 28 and its attachment to member 22 provide a suitable locking and unlocking of the clamp, for keeping it in a closed state when clamped onto a hose until such time as the user desires to release the clamp.

The spacing of the mounting holes on members 16, 22 is such that when fully closed, a small gap 48 will exist between the mating faces of members 12, 14, to provide sufficient space for the sidewalls of the hose to deform into.

In a particular embodiment, the portions 12, 14 and 28 are formed of metal, e.g. aluminum bar stock, but this is not a requirement, as other suitable materials may be employed, such as other metals, wood, plastic or other synthetics or composite materials. Members 16 and 22 are also suitably of metal in the particular embodiment, but can also be made of other materials.

Thus, in accordance with the invention, a clamp that is quickly attachable and releasable is provided that may be used to quickly clamp and unclamp a hose, such as a bellows type hose in a washing machine, for example, for quicker repair operations.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A quick engage and release hose clamp comprising:
a first and a second clamp jaw member, hingedly attached to one another; and
a cam lock member for setting said clamp between an engaged and disengaged state.

2. The quick engage and release hose clamp according to claim 1, wherein said first and second clamp jaw members comprises elongate bar members

3. The quick engage and release hose clamp according to claim 1, wherein said cam lock member is removably engageable with one of said first and second jaw members.

4. The quick engage and release hose clamp according to claim 1, wherein said first and second jaw members are formed as metal elongate bar members.

5. A quick engage and release hose clamp comprising:
a first elongate clamp member having first and second ends,
a second elongate clamp member having first and second ends,
a first connection member having first and second ends;
wherein said first ends of said first and second elongate clamp members are rotatably connected to said first connection member at first and second ends thereof;
a second elongate connection member having first and second ends, a first end thereof being rotatably connected to said second end of said first elongate bar member;
a locking member rotatably connected to said second end of said second elongate connection member, whereby rotation of said locking member to a first position enables locking said first and second clamp members to a closed position and rotation of said locking member to second position enables said first and second clamp members to be moved to an open position.

6. The quick engage and release hose clamp according to claim 5, wherein said locking member comprises a cam member adapted to interact with a surface of said second elongate clamp member.

7. A clamp, comprising:
a first elongate rectangular bar,
a second elongate rectangular bar,
a connection member hingedly attached to said first and second rectangular bars, whereby said first and second bars form clamp jaws and said connection member defines the pivot points of said clamp jaws;
a locking cam member mounted in swinging relation to and end of one of said elongate bars for enabling said locking cam member to swing into engagement with an end of the other of said elongate bars for releasably locking said clamp jaws into a closed position.
